(19) United States
(12) Patent Application Publication
(10) Pub. No.: US 2022/0373505 A1
(43) Pub. Date: Nov. 24, 2022

(54) GAS SENSOR AND METHOD OF MANUFACTURING GAS SENSOR

(71) Applicant: ROHM CO., LTD., Kyoto (JP)

(72) Inventor: Shunsuke AKASAKA, Kyoto (JP)

(21) Appl. No.: 17/663,084

(22) Filed: May 12, 2022

(30) Foreign Application Priority Data
May 19, 2021 (JP) 2021-084657

(51) Int. Cl. G01N 27/41; G01N 27/30; G01N 27/407

(52) U.S. Cl. CPC G01N 27/41; G01N 27/304; G01N 27/4073

(57) ABSTRACT

There is provided a method of manufacturing a gas sensor that includes: forming an insulating layer on a main surface of a substrate; forming a porous oxide layer on the insulating layer; and forming a porous metal layer on the porous oxide layer, wherein the forming the porous metal layer is performed by depositing a constituent material of the porous metal layer in an inclined direction with respect to a normal line of a main surface.

### CROSS-REFERENCE TO RELATED APPLICATION

This application is based upon and claims the benefit of priority from Japanese Patent Application No. 2021-084657, filed on May 19, 2021, the entire contents of which are incorporated herein by reference.

### TECHNICAL FIELD

The present disclosure relates to a gas sensor and a method of manufacturing the gas sensor.

### BACKGROUND

A gas sensor disclosed in the related art includes a substrate, an insulating layer, a micro heater, a porous oxide layer, a first porous metal layer, a solid electrolyte layer, and a second porous metal layer.

There is a cavity formed in the substrate. The cavity passes through the substrate along a thickness direction. The insulating layer is arranged on the substrate. The micro heater is arranged in a portion of the insulating layer (hereinafter referred to as a “membrane portion”) on the cavity. The porous oxide layer is arranged on the membrane portion. The first porous metal layer is arranged on the porous oxide layer. The solid electrolyte layer is arranged on the first porous metal layer. The second porous metal layer is arranged on the solid electrolyte layer.

In the gas sensor disclosed in the related art, the first porous metal layer is formed by sputtering. However, when the first porous metal layer is formed by sputtering, since a special condition (sputtering at a low degree of vacuum) is required, a general-purpose sputtering apparatus cannot be applied. As a result, it is necessary to introduce a dedicated sputtering apparatus in order to form the first porous metal layer, which increases the manufacturing cost.

### SUMMARY

Some embodiments of the present disclosure provide a gas sensor capable of reducing the manufacturing cost and a method of manufacturing the gas sensor.

According to one embodiment of the present disclosure, there is provided a method of manufacturing a gas sensor that includes: forming an insulating layer on a main surface of a substrate; forming a porous oxide layer on the insulating layer; and forming a porous metal layer on the porous oxide layer, wherein the forming the porous metal layer is performed by depositing a constituent material of the porous metal layer in an inclined direction with respect to a normal line of a main surface.

According to another embodiment of the present disclosure, there is provided a gas sensor that includes: a substrate; an insulating layer arranged on the substrate; a wiring arranged in the insulating layer; a porous oxide layer; a first porous metal layer arranged on the porous oxide layer; a solid electrolyte layer arranged on the first porous metal layer; and a second porous metal layer arranged on the solid electrolyte layer. The substrate is formed with a cavity that passes through the substrate in a thickness direction. The insulating layer includes a membrane portion on the cavity. The wiring includes a heater part arranged in the membrane portion. The porous oxide layer is arranged on the membrane portion. The first porous metal layer is composed of a plurality of spiral structures. Each of the plurality of spiral structures extends spirally along the thickness direction.

### BRIEF DESCRIPTION OF DRAWINGS

FIG. 1 is a cross-sectional view of a gas sensor 100.

FIG. 2 is a schematic view showing an internal structure of a porous oxide layer 50.

FIG. 3 is a schematic view showing an internal structure of a porous metal layer 60.

FIG. 4 is a process diagram showing a method of manufacturing the gas sensor 100.

FIG. 5 is a cross-sectional view for explaining a first insulating layer forming step S2.

FIG. 6 is a cross-sectional view for explaining a first wiring forming step S3.

FIG. 7 is a cross-sectional view for explaining a second insulating layer forming step S4.

FIG. 8 is a cross-sectional view for explaining a second wiring forming step S5.

FIG. 9 is a cross-sectional view for explaining a third insulating layer forming step S6.

FIG. 10 is a cross-sectional view for explaining a porous oxide layer forming step S7.

FIG. 11 is a schematic diagram for explaining a mechanism for forming a spiral structure 51 in the porous oxide layer forming step S7.

FIG. 12 is a cross-sectional view for explaining a first porous metal layer forming step S8.

FIG. 13 is a cross-sectional view for explaining a solid electrolyte layer forming step S9.

FIG. 14 is a cross-sectional view for explaining a patterning step S10.

FIG. 15 is a cross-sectional view for explaining a fourth insulating layer forming step S11.

FIG. 16 is a cross-sectional view for explaining a second porous metal layer forming step S12.

FIG. 17 is a graph showing a relationship between a deposition direction of a constituent material of a porous metal layer 60 and a relative density of the porous metal layer 60.

### DETAILED DESCRIPTION

Embodiments of the present disclosure will now be described in detail with reference to the drawings. Throughout the drawings, the same or corresponding parts are denoted by the same reference numerals, and explanation thereof will not be repeated.

(Configuration of Gas Sensor according to Embodiment)

A gas sensor (referred to as a “gas sensor 100”) according to an embodiment will be described below.

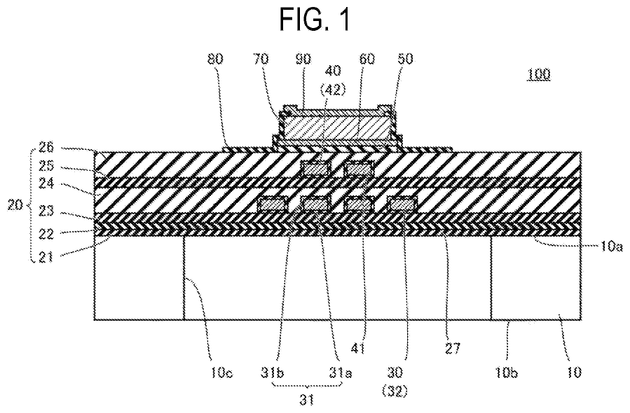

FIG. 1 is a cross-sectional view of the gas sensor 100. As shown in FIG. 1, the gas sensor 100 includes a substrate 10, an insulating layer 20, a wiring 30, and a wiring 40. The gas sensor 100 further includes a porous oxide layer 50, a porous metal layer 60, a solid electrolyte layer 70, an insulating layer 80, and a porous metal layer 90.

The substrate 10 is formed of, for example, single crystal silicon. The substrate 10 has a main surface 10a and a main surface 10b. The main surface 10a and the main surface 10b are end faces of the substrate 10 in a thickness direction. The main surface 10b is the opposite surface of the main surface 10a. A cavity 10c is formed in the substrate 10. The cavity 10c passes through the substrate 10 along the thickness direction.

The insulating layer 20 is arranged on the substrate 10. More specifically, the insulating layer 20 is formed on the main surface 10a. The insulating layer 20 includes a first layer 21, a second layer 22, a third layer 23, a fourth layer 24, a fifth layer 25, and a sixth layer 26.

The first layer 21 is formed of, for example, silicon oxide. The first layer 21 is arranged on the substrate 10 (on the main surface 10a). The second layer 22 is formed of, for example, silicon nitride. The second layer 22 is arranged on the first layer 21. The third layer 23 and the fourth layer 24 are formed of, for example, silicon oxide. The third layer 23 is arranged on the second layer 22. The fourth layer 24 is arranged on the third layer 23.

The fifth layer 25 is formed of, for example, silicon nitride. The fifth layer 25 is arranged on the fourth layer 24. The sixth layer 26 is formed of, for example, silicon oxide. The sixth layer 26 is arranged on the fifth layer 25.

The insulating layer 20 includes a membrane portion 27. The membrane portion 27 is a portion of the insulating layer 20 on the cavity 10c.

The wiring 30 is arranged in the insulating layer 20. More specifically, the wiring 30 is arranged on the third layer 23 and is covered by the fourth layer 24. The wiring 30 is formed of, for example, platinum. The periphery of the wiring 30 is covered by an adhesion layer 31. The adhesion layer 31 is formed of, for example, titanium oxide. The adhesion between the insulating layer 20 and the wiring 30 is secured by the adhesion layer 31. The adhesion layer 31 includes a first portion 31a and a second portion 31b. The first portion 31a is arranged on the third layer 23. The wiring 30 is arranged on the first portion 31a. The second portion 31b covers the wiring 30.

The wiring 30 has a heater part 32. The heater part 32 is a portion of the wiring 30, which is arranged within the membrane portion 27 and is winding in a plan view. The heater part 32 through which current passes is resistance-heated.

The wiring 40 is arranged in the insulating layer 20. More specifically, the wiring 40 is arranged on the fifth layer 25 and is covered by the sixth layer 26. The wiring 40 is formed of, for example, platinum. The periphery of the wiring 40 is covered by an adhesion layer 41. The adhesion layer 41 is formed of, for example, titanium oxide. The adhesion between the insulating layer 20 and the wiring 40 is secured by the adhesion layer 41.

The wiring 40 has a temperature sensor part 42. The temperature sensor part 42 is a portion of the wiring 40, which is arranged in the membrane portion 27 and is winding in a plan view. The temperature sensor part 42 overlaps with the heater part 32 in a plan view. The temperature sensor part 42 functions as a resistance thermometer bulb. That is, a temperature in the vicinity of the temperature sensor part 42 is measured by measuring a change in electric resistance value of the wiring 40 constituting the temperature sensor part 42.

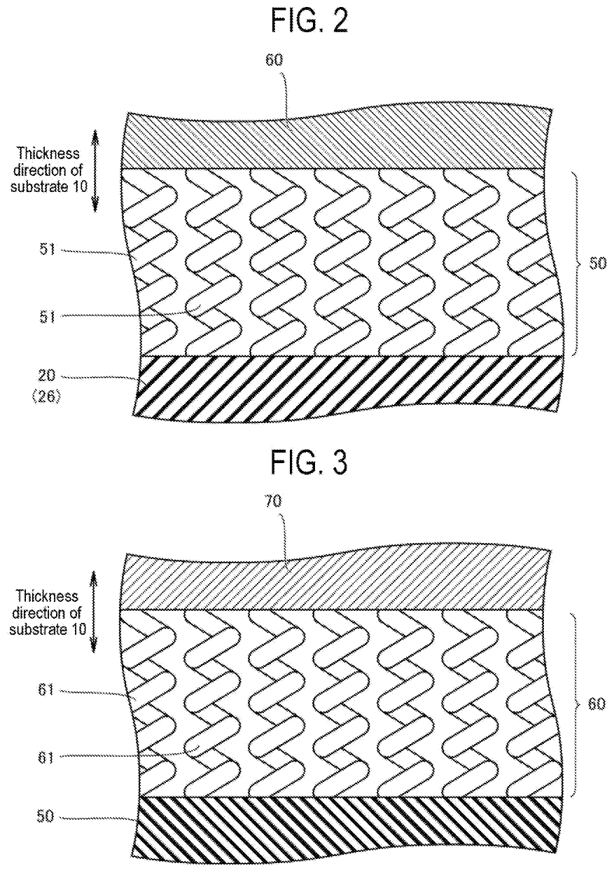

The porous oxide layer 50 is arranged on the insulating layer 20. More specifically, the porous oxide layer 50 is arranged over the membrane portion 27. FIG. 2 is a schematic view showing the internal structure of the porous oxide layer 50. As shown in FIG. 2, it is desirable that the porous oxide layer 50 is composed of a plurality of spiral structures 51. Each spiral structure 51 extends spirally along the thickness direction of the substrate 10. That is, the spiral structure 51 extends along the thickness direction of the substrate 10 while rotating around the central axis along the thickness direction of the substrate 10.

As shown in FIG. 1, the porous metal layer 60 is arranged on the porous oxide layer 50. The porous metal layer 60 is formed of, for example, platinum. The porous metal layer 60 is a cathode.

It is desirable that the relative density of the porous metal layer 60 is 0.5 or more. The relative density of the porous metal layer 60 is a value obtained by dividing the density of the porous metal layer 60 by the density of the constituent material of the porous metal layer 60. The density of the porous metal layer 60 is a value obtained by dividing the weight of the porous metal layer 60 by the apparent volume of the porous metal layer 60 (the sum of the volume of the constituent material of the porous metal layer 60 and the volume of the voids in the porous metal layer 60).

FIG. 3 is a schematic view showing an internal structure of the porous metal layer 60. As shown in FIG. 3, it is desirable that the porous metal layer 60 is composed of a plurality of spiral structures 61. Each spiral structure 61 extends spirally along the thickness direction of the substrate 10. That is, the spiral structure 61 extends along the thickness direction of the substrate 10 while rotating around the central axis along the thickness direction of the substrate 10.

As shown in FIG. 1, the solid electrolyte layer 70 is arranged on the porous metal layer 60. The solid electrolyte layer 70 is formed of an oxygen ion conductor. The solid electrolyte layer 70 is formed of, for example, yttria-stabilized zirconia.

The insulating layer 80 is arranged on the insulating layer 20 so as to cover the porous oxide layer 50, the porous metal layer 60, and the solid electrolyte layer 70. However, the insulating layer 80 is formed with an opening that partially exposes the solid electrolyte layer 70. The insulating layer 80 is, for example, a layer in which a silicon oxide layer and a tantalum oxide layer are stacked.

The porous metal layer 90 is arranged on a portion of the solid electrolyte layer 70, which is exposed from the insulating layer 80. The porous metal layer 90 is formed of, for example, platinum. The porous metal layer 90 is an anode.

The heater part 32 through which current passes generates heat and heats the solid electrolyte layer 70. As a result, the solid electrolyte layer 70 exhibits oxygen ion conductivity. A gas around the gas sensor 100 reaches the porous metal layer 60 through the porous oxide layer 50. An oxygen gas in the gas that reaches the porous metal layer 60 accepts electrons from the porous metal layer 60, so that oxygen ions are generated.

The oxygen ions move within the solid electrolyte layer 70 due to a voltage between the porous metal layer 60 and the porous metal layer 90. The oxygen ions that reach the porous metal layer 90 emit electrons to the porous metal layer 90, thereby becoming an oxygen gas. At this time, a current flows between the porous metal layer 60 and the porous metal layer 90. Since this current is proportional to the concentration of oxygen gas, the gas sensor 100 can detect the concentration of oxygen gas in the gas around the gas sensor 100 by detecting this current. The concentration of water vapor in the gas around the gas sensor 100 is also detected in the same manner.

(Method of Manufacturing Gas Sensor according to Embodiment)

A method of manufacturing the gas sensor 100 will be described below.

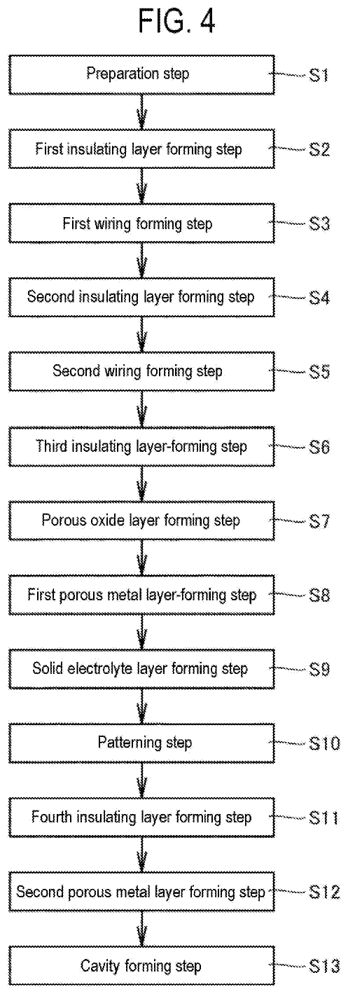

FIG. 4 is a process diagram showing the method of manufacturing the gas sensor 100. As shown in FIG. 4, the method of manufacturing the gas sensor 100 includes a preparation step S1, a first insulating layer forming step S2, a first wiring forming step S3, a second insulating layer forming step S4, a second wiring forming step S5, a third insulating layer forming step S6, a porous oxide layer forming step S7, a first porous metal layer forming step S8, a solid electrolyte layer forming step S9, a patterning step S10, a fourth insulating layer forming step S11, a second porous metal layer forming step S12, and a cavity forming step S13.

In the preparation step S1, the substrate 10 is prepared. The cavity 10c is not formed in the substrate 10 prepared in the preparation step S1.

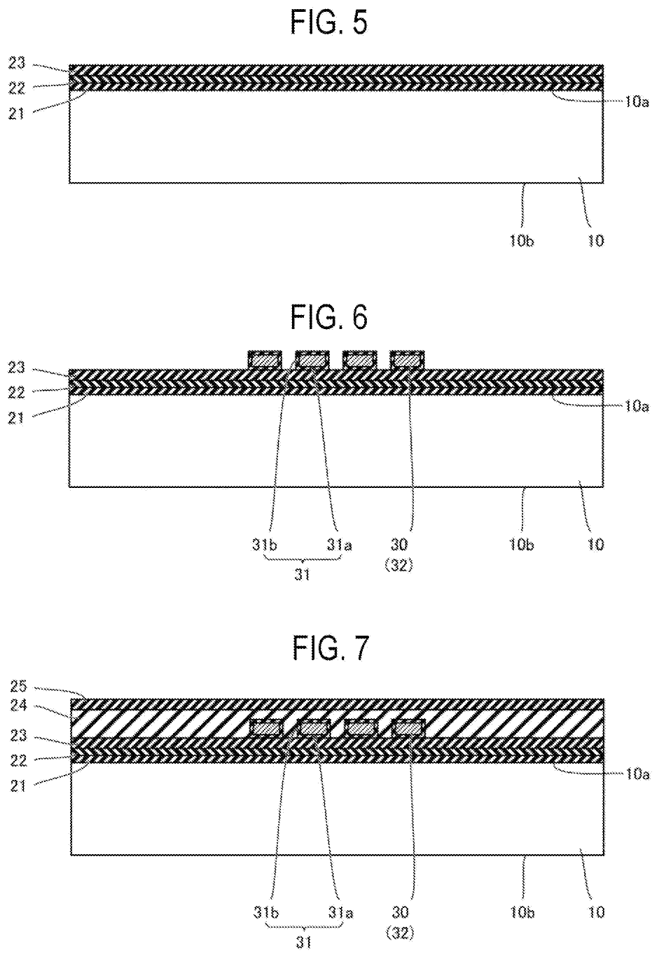

FIG. 5 is a cross-sectional view for explaining the first insulating layer forming step S2. As shown in FIG. 5, in the first insulating layer forming step S2, the first layer 21, the second layer 22, and the third layer 23 are sequentially formed. The formation of the first layer 21, the second layer 22, and the third layer 23 is performed, for example, by using a CVD (Chemical Vapor Deposition) method.

FIG. 6 is a cross-sectional view for explaining the first wiring forming step S3. In the first wiring forming step S3, the wiring 30 and the adhesion layer 31 are formed as shown in FIG. 6.

In the first wiring forming step S3, first, the first portion 31a is formed by forming a film with the constituent material of the adhesion layer 31 and patterning the film. This film formation is performed by, for example, sputtering. This patterning is performed, for example, by forming a mask using photolithography and etching using the mask.

In the first wiring forming step S3, second, the wiring 30 is formed by forming a film with the constituent materials of the wiring 30 and patterning the film. This film formation is performed by, for example, sputtering. This patterning is performed, for example, by forming a mask using photolithography and etching using the mask.

In the first wiring forming step S3, third, the second portion 3 lb is formed by forming a film with the constituent material of the adhesion layer 31 and patterning the film. This film formation is performed by, for example, sputtering. This patterning is performed, for example, by forming a mask using photolithography and etching using the mask.

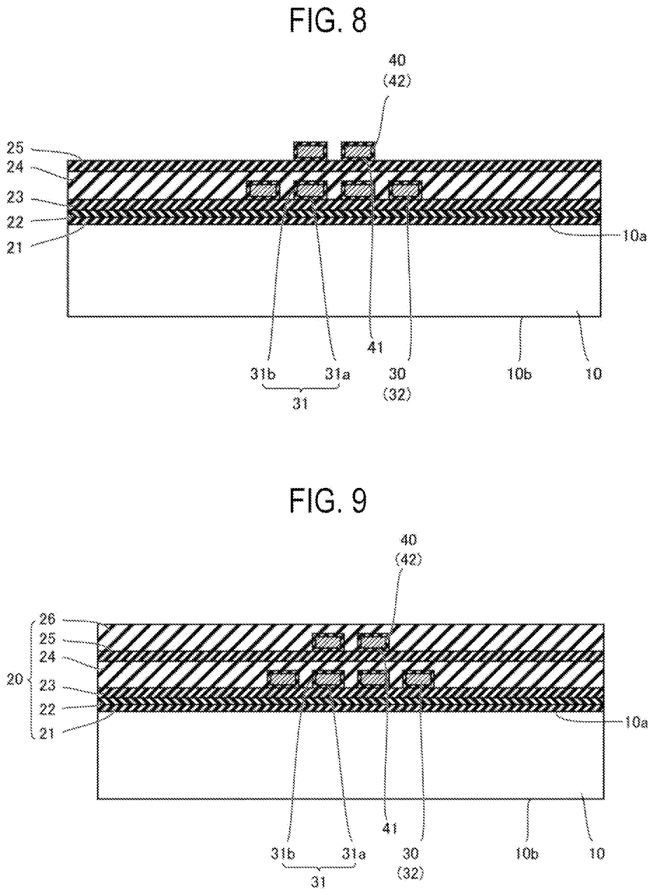

FIG. 7 is a cross-sectional view for explaining the second insulating layer forming step S4. As shown in FIG. 7, in the second insulating layer forming step S4, the fourth layer 24 and the fifth layer 25 are sequentially formed. The formation of the fourth layer 24 and the fifth layer 25 is performed, for example, by using a CVD method. FIG. 8 is a cross-sectional view for explaining the second wiring forming step S5. As shown in FIG. 8, in the second wiring forming step S5, the wiring 40 and the adhesion layer 41 are formed. The wiring 40 and the adhesion layer 41 are formed by the same method as the wiring 30 and the adhesion layer 41.

FIG. 9 is a cross-sectional view for explaining the third insulating layer forming step S6. As shown in FIG. 9, in the third insulating layer forming step S6, the sixth layer 26 is formed. The formation of the sixth layer 26 is performed, for example, by using a CVD method.

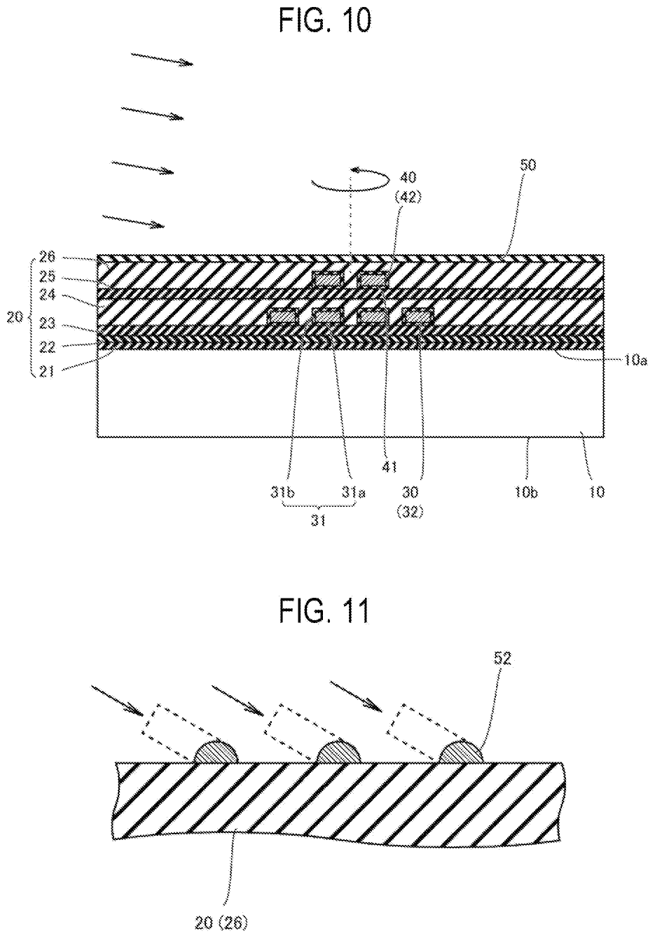

FIG. 10 is a cross-sectional view for explaining the porous oxide layer forming step S7. An arrow in FIG. 10 indicates a deposition direction of the constituent material of the porous oxide layer 50. As shown in FIG. 10, in the porous oxide layer forming step S7, the porous oxide layer 50 is formed. The porous oxide layer 50 is formed by depositing the constituent material of the porous oxide layer 50. This deposition is performed in a direction inclined with respect to the normal line of the main surface 10a. When this deposition is performed, it is desirable that the substrate 10 is rotated at least once around a rotation axis (see a dotted line in FIG. 10) along the normal line of the main surface 10a.

FIG. 11 is a schematic diagram for explaining a mechanism for forming the spiral structure 51 in the porous oxide layer forming step S7. An arrow in FIG. 11 indicates a deposition direction of the constituent material of the porous oxide layer 50. As shown in FIG. 11, when the deposition of the constituent material of the porous oxide layer 50 is started, aggregated nuclei 52 made of the constituent material of the porous oxide layer 50 are formed on the insulating layer 20.

The deposition of the constituent material of the porous oxide layer 50 is performed in an inclined direction with respect to the normal line of the main surface 10a. Therefore, the constituent material of the porous oxide layer 50 is not deposited on a portion that becomes a shadow of the aggregated nuclei 52. As a result, the constituent material of the porous oxide layer 50 is deposited on the aggregated nuclei 52 along the deposition direction (see a dotted line in FIG. 11). When the constituent material of the porous oxide layer 50 is deposited, the substrate 10 is rotated around a rotation axis along the normal line of the main surface 10a. Therefore, a direction in which the constituent material of the porous oxide layer 50 is deposited is also changed with this rotation. As a result, the spiral structure 51 is formed.

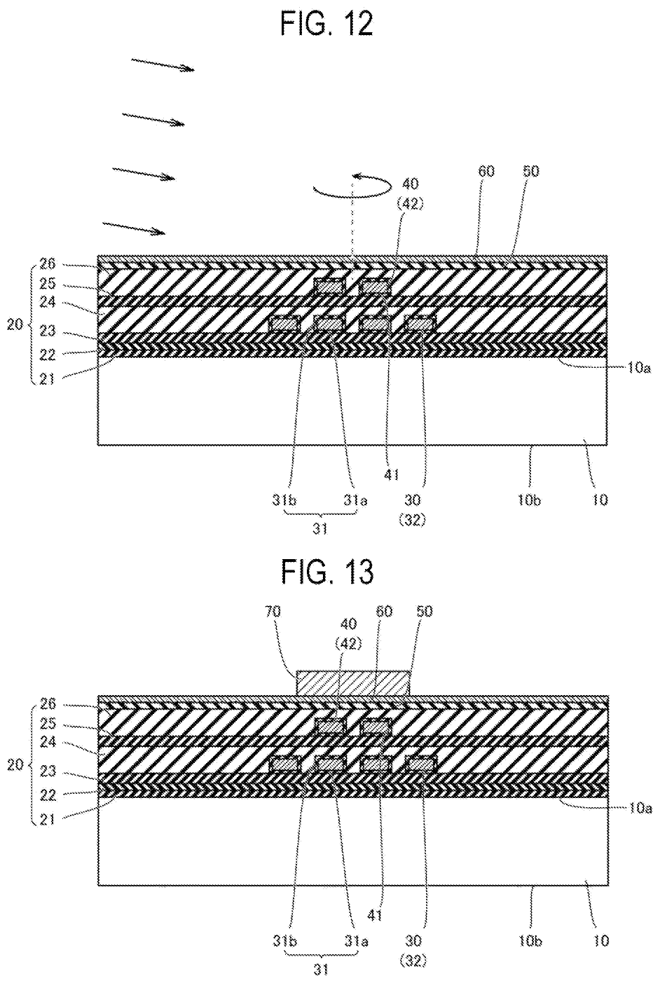

FIG. 12 is a cross-sectional view for explaining the first porous metal layer forming step S8. An arrow in FIG. 12 indicates a deposition direction of the constituent material of the porous metal layer 60. As shown in FIG. 12, in the first porous metal layer forming step S8, the porous metal layer 60 is formed. The porous metal layer 60 is formed by depositing the constituent material of the porous metal layer 60 in an inclined direction with respect to the main surface 10a. It is desirable that this deposition is performed in a direction inclined by 80 degrees or more and less than 90 degrees with respect to the main surface 10a. When this deposition is performed, it is desirable that the substrate 10 is rotated at least once around the rotation axis (see a dotted line in FIG. 12) along the normal line of the main surface 10a. As a result, the spiral structure 61 is formed.

It is desirable that the porous oxide layer forming step S7 and the first porous metal layer forming step S8 are performed using the same deposition apparatus.

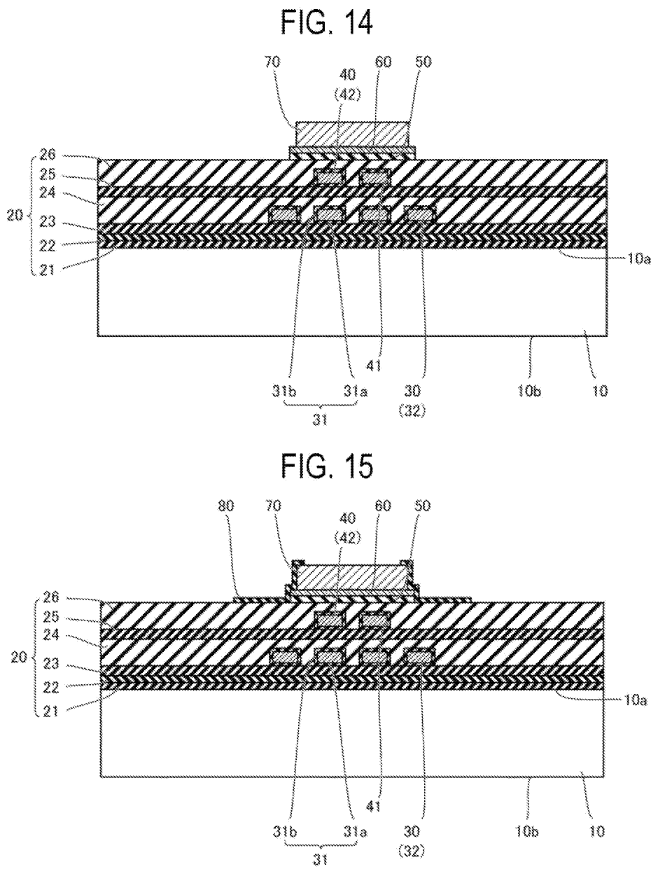

FIG. 13 is a cross-sectional view for explaining the solid electrolyte layer forming step S9. As shown in FIG. 13, in the solid electrolyte layer forming step S9, the solid electrolyte layer 70 is formed. The solid electrolyte layer 70 is formed by forming a film with the constituent material of the solid electrolyte layer 70 and patterning the film. This film formation is performed by, for example, sputtering. This patterning is performed by, for example, dry etching. FIG. 14 is a cross-sectional view for explaining the patterning step S10. As shown in FIG. 14, in the patterning step S10, the porous oxide layer 50 and the porous metal layer 60 are patterned. This patterning is performed by, for example, dry etching.

FIG. 15 is a cross-sectional view for explaining the fourth insulating layer forming step S11. As shown in FIG. 15, in the fourth insulating layer forming step S11, the insulating layer 80 is formed. The insulating layer 80 is formed by, for example, sputtering. The insulating layer 80 is formed with an opening that partially exposes the solid electrolyte layer 70 by performing etching.

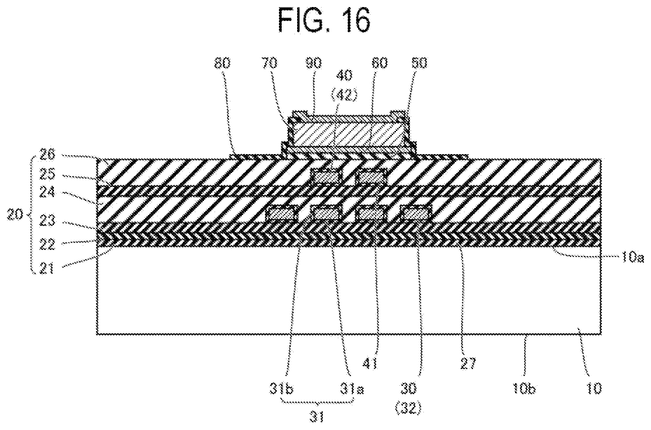

FIG. 16 is a cross-sectional view for explaining the second porous metal layer forming step S12. As shown in FIG. 16, in the second porous metal layer forming step S12, the porous metal layer 90 is formed. The porous metal layer 90 is formed by forming a film with the constituent material of the porous metal layer 90 and patterning the film. This film formation is performed by, for example, sputtering. This patterning is performed by, for example, dry etching.

In the cavity forming step S13, the cavity 10c is formed by, for example, wet etching. From the above, the gas sensor 100 having the structure shown in FIG. 1 is formed.

(Effects of Gas Sensor and Method of Manufacturing the Same according to Embodiment)

The effects of the gas sensor 100 and the method of manufacturing the gas sensor 100 will be described below.

When the porous metal layer 60 is to be formed by sputtering, since it is necessary to perform the sputtering under a condition that a degree of vacuum is low, a general-purpose sputtering apparatus cannot be used. That is, when the porous metal layer 60 is to be formed by sputtering, a dedicated sputtering apparatus capable of performing the sputtering under the condition that a degree of vacuum is low is required, which increases the manufacturing cost.

On the other hand, in the method of manufacturing the gas sensor 100, the porous metal layer 60 is formed by depositing the constituent material of the porous metal layer 60 in the inclined direction with respect to the main surface 10a. This deposition can be realized by using a general-purpose deposition apparatus. Further, in the method of manufacturing the gas sensor 100, since the porous oxide layer 50 is also formed by the same method as the porous metal layer 60, the deposition apparatus used for forming the porous metal layer 60 can be shared for the formation of the porous oxide layer 50. Therefore, according to the gas sensor 100 and the method of manufacturing the gas sensor 100, it is possible to reduce the manufacturing cost.

When the porous metal layer 60 is to be formed by sputtering, since it is necessary to perform the sputtering under a condition that a degree of vacuum is low, there is a concern that the in-plane uniformity of the thickness of the porous metal layer 60 may be lowered. On the other hand, in the method of manufacturing the gas sensor 100, the substrate 10 is rotated around the rotation axis along the normal line of the main surface 10a when the deposition is performed. Therefore, according to the gas sensor 100 and the method of manufacturing the gas sensor 100, the in-plane uniformity of the thickness of the porous metal layer 60 is maintained even if the deposition is performed in the inclined direction with respect to the normal line of the main surface 10a.

Further, in the method of manufacturing the gas sensor 100, since the substrate 10 is rotated around the rotation axis along the normal line of the main surface 10a when the deposition is performed, the porous metal layer 60 is composed of a plurality of spiral structures 61.

When the gas sensor 100 is operating, since the solid electrolyte layer 70 is heated to a high temperature (when the solid electrolyte layer 70 is formed of yttria-stabilized zirconia, it is heated to about 500 degrees C.), a thermal stress acts on the solid electrolyte layer 70. In the gas sensor 100, since the spiral structure 61 acts as a spring to relieve the thermal stress applied to the solid electrolyte layer 70, the solid electrolyte layer 70 is prevented from being damaged by the thermal stress.

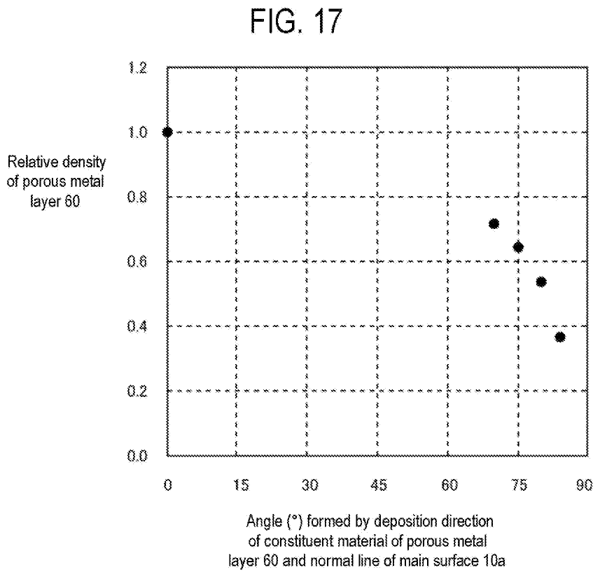

FIG. 17 is a graph showing a relationship between the deposition direction of the constituent material of the porous metal layer 60 and the relative density of the porous metal layer 60. In FIG. 17, the horizontal axis represents an angle (unit:°) formed by the deposition direction of the constituent material of the porous metal layer 60 and the normal line of the main surface 10a, and the vertical axis represents the relative density of the porous metal layer 60 (no unit). As shown in FIG. 17, by depositing the constituent material of the porous metal layer 60 in a direction inclined by 80 degrees or more and less than 90 degrees with respect to the main surface 10a, the relative density of the porous metal layer 60 can be set to 0.5 or less.

As the relative density of the porous metal layer 60 decreases, the number of voids in the porous metal layer 60 increases, so that the deformability of the porous metal layer 60 can increase to easily relax the thermal stress applied to the solid electrolyte layer 70. Therefore, by depositing the constituent material of the porous metal layer 60 in the direction inclined by 80 degrees or more and less than 90 degrees with respect to the main surface 10a (setting the relative density of the porous metal layer 60 to 0.5 or less), the solid electrolyte layer 70 is prevented from being damaged by the thermal stress.

Although the embodiment of the present disclosure has been described as described above, the above-described embodiment can be variously modified. Moreover, the scope of the present disclosure is not limited to the above-described embodiment. The scope of the present disclosure is indicated by the claims and is intended to include all modifications within the meaning and scope equivalent to the claims.

According to the gas sensor of the present disclosure and the method of manufacturing the gas sensor, it is possible to reduce the manufacturing cost.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A method of manufacturing a gas sensor, comprising:
forming an insulating layer on a main surface of a substrate;
forming a porous oxide layer on the insulating layer; and
forming a porous metal layer on the porous oxide layer,
wherein the forming the porous metal layer is performed by depositing a constituent material of the porous metal layer in an inclined direction with respect to a normal line of the main surface.

2. The method of claim 1, wherein the forming the porous metal layer is performed while rotating the substrate at least once around a rotation axis along the normal line of the main surface.

3. The method of claim 1, wherein the forming the porous metal layer is performed by depositing the constituent material of the porous metal layer in a direction inclined by 80 degrees or more and less than 90 degrees with respect to the normal line of the main surface.

4. The method of claim 1, wherein the forming the porous oxide layer is performed by depositing a constituent material of the porous oxide layer in the inclined direction with respect to the normal line of the main surface.

5. The method of claim 4, wherein the forming the porous metal layer and the forming the porous oxide layer are performed in a same deposition apparatus.

6. A gas sensor comprising:
a substrate;
an insulating layer arranged on the substrate;
a wiring arranged in the insulating layer;
a porous oxide layer;
a first porous metal layer arranged on the porous oxide layer;
a solid electrolyte layer arranged on the first porous metal layer; and
a second porous metal layer arranged on the solid electrolyte layer,
wherein the substrate is formed with a cavity that passes through the substrate in a thickness direction,
wherein the insulating layer includes a membrane portion on the cavity,
wherein the wiring includes a heater part arranged in the membrane portion,
wherein the porous oxide layer is arranged on the membrane portion,
wherein the first porous metal layer is composed of a plurality of spiral structures, and
wherein each of the plurality of spiral structures extends spirally along the thickness direction.

7. The gas sensor of claim 6, wherein a relative density of the first porous metal layer is 0.5 or less.
